(19) United States
(12) Patent Application Publication
(10) Pub. No.: US 2024/0127076 A1
(43) Pub. Date: Apr. 18, 2024

(54) METHOD AND SYSTEM FOR FEDERATED DATA PROCUREMENT USING PROBABILISTIC INFORMATION MATCHING VIA DOMAIN SPECIFIC HEURISTICS

(71) Applicants: MICHAEL FALLIHEE, helena, MT (US); SRIDHAR CHANDRASHEKAR, SAMMAMISH, WA (US); MOHAN THIMMAPPA, redmond, WA (US)

(72) Inventors: MICHAEL FALLIHEE, helena, MT (US); SRIDHAR CHANDRASHEKAR, SAMMAMISH, WA (US); MOHAN THIMMAPPA, redmond, WA (US)

(21) Appl. No.: 18/368,221

(22) Filed: Sep. 14, 2023

Related U.S. Application Data
(63) Continuation of application No. 18/239,102, filed on Aug. 28, 2023.
(60) Provisional application No. 63/402,213, filed on Aug. 30, 2022.
(60) Provisional application No. 63/402,213, filed on Aug. 30, 2022.

(51) Int. Cl. G06N 5/01; G16Y 40/10

(52) U.S. Cl. CPC G06N 5/01; G16Y 40/10

(57) ABSTRACT

In one aspect, a computerized method for federated data procurement using probabilistic information matching via domain specific heuristics. The method includes implementing procurement of the data from a plurality of online data sources. Each online data source comprises a plurality of measures. The method includes matching and validating the data. The method includes associating a plurality of weights with the plurality of set of domain specific heuristics that are optimized on an ongoing basis as newer data sources are identified. The method includes detecting that new information is collected and adding a plurality of additional heuristics to the domain specific heuristic frameworks.

### CLAIM OF PRIORITY

This application claims priority to U.S. Provisional Patent Application No. 63/402,213, filed on Aug. 30, 2022 and titled Federated data procurement using probabilistic information matching via domain specific heuristics. This provisional patent application is hereby incorporated by reference in its entirety.

This application claims priority to U.S. Provisional patent application Ser. No. 18/239,102, filed on Aug. 28, 2023 and titled Method and Systems for Cloud Security Operations. This utility patent application is hereby incorporated by reference in its entirety.

U.S. Provisional patent application Ser. No. 18/239,102 claims priority to U.S. Provisional Patent Application No. 63/402,213, filed on Aug. 30, 2022 and titled Federated data procurement using probabilistic information matching via domain specific heuristics.

### BACKGROUND

Managing and persisting data that is procured in a concurrent, distributed, scalable manner from a federated set of data sources and keeping that data updated is a difficult problem. This is especially the case in the context of IIoT devices. We propose a mechanism where we can programmatically procure data in an ongoing manner and keep the database updated by using probabilistic information matching combined with domain specific heuristics.

### SUMMARY OF THE INVENTION

In one aspect, a computerized method for federated data procurement using probabilistic information matching via domain specific heuristics. The method includes implementing procurement of the data from a plurality of online data sources. Each online data source comprises a plurality of measures; matching and validating the data by: identifying the data to be stored, identifying a data source of the data, matching a procured data with the data that is currently present in a database and validating data efficacy of the data. The method includes identifying a set of domain specific heuristics that make up an overall heuristic framework. The method includes associating a plurality of weights with the plurality of set of domain specific heuristics that are optimized on an ongoing basis as newer data sources are identified. The method includes detecting that new information is collected and adding a plurality of additional heuristics to the domain specific heuristic frameworks.

### BRIEF DESCRIPTION OF THE DRAWINGS

FIG. 1 illustrates an example process for federated data procurement using probabilistic information matching via domain specific heuristics, according to some embodiments.

FIG. 2 illustrates an example schematic useful for maintaining an IIoT device database up to date, according to some embodiments.

FIG. 3 illustrates another example process for federated data procurement using probabilistic information matching via domain specific heuristics, according to some embodiments.

FIG. 4 illustrates an example table showing an example set of properties for one or more connected devices, according to some embodiments.

FIG. 5 illustrates another example process for federated data procurement using probabilistic information matching via domain specific heuristics, according to some embodiments.

FIG. 6 illustrates an example process for matching and validating the data, according to some embodiments.

The Figures described above are a representative set and are not an exhaustive with respect to embodying the invention.

### DESCRIPTION

Disclosed are a system, method, and article of manufacture for federated data procurement using probabilistic information matching via domain specific heuristics. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment’; ‘an embodiment,’ ‘one example,’ or similar language means that a particular feature, structure, or characteristic described in connection with the embodiment is included in at least one embodiment, according to some embodiments. Thus, appearances of the phrases ‘in one embodiment’; ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Cloud computing architecture refers to the components and subcomponents required for cloud computing. These components typically consist of a front-end platform (fat client, thin client, mobile), back-end platforms (servers, storage), a cloud-based delivery, and a network (Internet, Intranet, Intercloud). Combined, these components can make up cloud computing architecture. Cloud computing architectures and/or platforms can be referred to as the ‘cloud’ herein as well.

Cloud resource model (CRM) provides ability to define resource characteristics, Hierarchy, dependencies, and its action in a declarative model and embed them in Open API specification. CRM allows both humans and computers to understand and discover capabilities and characteristics of cloud service and its resources.

Distributed control system (DCS) is a computerized control system for a process or plant usually with many control loops, in which autonomous controllers are distributed throughout the system, but there is no central operator supervisory control. This is in contrast to systems that use centralized controllers; either discrete controllers located at a central control room or within a central computer. Hyperscalers can be large cloud service providers. Hyperscalers can be the owners and operators of data centers where these horizontally linked servers are housed.

Internet of things (IoT) describes devices with sensors, processing ability, software and other technologies that connect and exchange data with other devices and systems over the Internet or other communications networks.

Industrial internet of things (IIoT) refers to interconnected sensors, instruments, and other devices networked together with computers' industrial applications, including manufacturing and energy management. This connectivity allows for data collection, exchange, and analysis, potentially facilitating improvements in productivity and efficiency as well as other economic benefits. The IIoT is an evolution of a distributed control system (DCS) that allows for a higher degree of automation by using cloud computing to refine and optimize the process controls.

Tree structure is a way of representing the hierarchical nature of a structure in a graphical form. In graph theory, a tree is an undirected graph in which any two vertices are connected by exactly one path, or equivalently a connected acyclic undirected graph. A forest is an undirected graph in which any two vertices are connected by at most one path, or equivalently an acyclic undirected graph, and/or equivalently a disjoint union of trees.

Example Systems and Methods

A multi-cloud governance platform is provided that empowers enterprises to rapidly achieve autonomous and continuous cloud governance and compliance at scale. Multi-cloud governance platform is delivered to end users in the form of multiple product offerings, bundled for a specific set of cloud governance pillars based on the client's needs. Example multi-cloud governance platform's offerings and associated cloud governance pillars are now discussed.

The multi-cloud governance platform can provide FinOps as a solution offering that is designed to help an entity develop a culture of financial accountability and realize the benefits of the cloud faster. The multi-cloud governance platform SecOps as a solution offering designed to help keep cloud assets secure and compliant. The multi-cloud governance platform is a solution offering designed to help optimize cloud operations and cost management in order to provide accessibility, availability, flexibility, and efficiency while also boosting business agility and outcomes. The multi-cloud governance platform provides a Well-Architected Assessment functionality (e.g. CoreStack Assessments®, etc.) that is designed to help an entity adopt best practices according to well-architected frameworks, gain continuous visibility, and manage risk of cloud workloads with assessments, policies, and reports that allow an administrator to review the state of applications and get a clear understanding of risk trends over time.

Well-Architected Assessment functionality helps enterprises adopt cloud best practices, manage risk, and maintain reliable, secure, resilient, cost-efficient, performant, and sustainable cloud infrastructures.

Cloud Governance Pillars that can be implemented by the multi-cloud governance platform are now discussed. The multi-cloud governance platform can enable governing of cloud assets involves cost-efficient and effective management of resources in a cloud environment while adhering to security and compliance standards. There are several factors that can be involved in a successful implementation of cloud governance. The multi-cloud governance platform has encompassed all these factors into its cloud governance pillars. The following table explains the key cloud governance pillars developed by Multi-cloud governance platform.

The multi-cloud governance platform utilizes various operations that provide the capability to operate and manage various cloud resources efficiently using various features such as automation, monitoring, notifications, activity tracking.

The multi-cloud governance platform utilizes various security operations that enable management of the security governance of various cloud accounts and identify the security vulnerabilities and threats and resolve them.

The multi-cloud governance platform utilizes various manages cost. The multi-cloud governance platform enables users to create a customized controlling mechanism that can control a customer's cloud expenses within budget and reduce cloud waste by continually discovering and eliminating inefficient resources.

The multi-cloud governance platform utilizes various access operations. The multi-cloud governance platform utilizes various allows administrators to configure secure access of resources in a cloud environment and protect the users' data and assets from unauthorized access.

The multi-cloud governance platform utilizes various resource management operations. The multi-cloud governance platform enables users to define, enforce, and track the resource naming and tagging standards, sizing, and their usage by region. It also enables a customer to follow consistent and standard practices pertaining to resource deployment, management, and reporting.

The multi-cloud governance platform utilizes various compliance actions. The multi-cloud governance platform guides users to assess a cloud environment for its compliance status against standards and regulations that are relevant to an organization—ISO, NIST, HIPAA, PCI, CIS, FedRAMP, AWS Well-Architected framework, and custom standards.

The multi-cloud governance platform utilizes various self-service operations. The multi-cloud governance platform enables administrators to configure a simplified self-service cloud consumption model for end users that are tied to approval workflows. It enables an entity to automate repetitive tasks and focus on key deliverables.

The multi-cloud governance platform continuously assess the state of the customer's cloud workloads against well-architected frameworks to manage risk and embrace best practices. The multi-cloud governance platform includes a Well-Architected Assessment functionality that designed to help adopt best practices, gain continuous visibility, and manage risk for cloud workloads with assessments, policies, and reports that allow a customer to review the state of a customer's applications and get a clear understanding of risk trends over time. Further, it automatically discovers issues and provides actionable insights for remediation, simplifying and streamlining the process of assessing, improving, and maintaining cloud workloads. The multi-cloud governance platform can onboard cloud accounts and manage workloads. In this way, the multi-cloud governance platform supports well-architected frameworks (WAF).

The Well-Architected Assessment functionality helps ensure user workloads are optimized as part of a strong cloud strategy in the following key areas: automate discovery and remediate at scale discovering issues across best practice areas for user cloud workloads can be difficult and time-consuming, which is why the multi-cloud governance platform implements auto-discovery and remediation features. This helps improve user productivity for detecting any issues in a cloud account or workloads and provides those insights for you to look into and remediate at scale. The Well-Architected Assessment functionality can enable collaboration with multiple teams and enable gathering information and collecting evidence for best practices can present challenges around collaboration. Since it's usually not a single person doing the assessment, but a group of people across different teams, the multi-cloud governance platform provides built-in collaboration features to make assessing user workloads easier. The Well-Architected Assessment functionality can be used to validate across multi-cloud workloads. The multi-cloud governance platform helps make it possible to validate best practices across multiple clouds by providing a single pane of glass to do a well-architected review across diverse workloads. The multi-cloud governance platform also supports a multi-cloud well architected framework for workloads that span across more than one cloud provider. The Well-Architected Assessment functionality can classify best practices. Cloud best practices can fall into multiple categories. As part of the Well-Architected Assessment functionality, the multi-cloud governance platform provides built-in pillars respective to each cloud platform (AWS, Azure, etc.) that organize best practices into relevant areas of focus, such as operations, security, sustainability, and more. The multi-cloud governance platform include these pillars to helps users clearly define which areas they need to focus on and guide you in terms of next steps to move towards a well-architected cloud infrastructure.

The Well-Architected Assessment functionality can enable map policies to workloads best practices for different cloud platforms are reinforced in the multi-cloud governance platform by built-in policies, which are mapped directly to various best practices. These policies help identify any violations in a workload based on a particular best practice. Policies come pre-loaded and pre-mapped, but you can also create and map a customer's policies. This enables you to validate user workloads against best practices with more ease and control. Automate best practices even with built in best practice classification and policies, validating user workloads against best well-architected frameworks can still require manual work.

The multi-cloud governance platform the Well-Architected Assessment functionality maps relevant policies to identify violations against certain best practice and can automate most of the work needed to validate user workloads and identify any violations, reducing the amount of overhead and effort needed on a user. Built-in suggestions for remediation can be provided. For many of The multi-cloud governance platform's automated policies, any identified violations that appear as part of an assessment will come with a suggested remediation to address it. These suggestions appear directly to the user in the multi-cloud governance platform web portal, making it easy to both find and fix any issues with user cloud workloads.

Built-in evidence tracking is provided. The multi-cloud governance platform can keep track of what steps were taken to implement best practices and address any violations is a key part of the cloud optimization process. The multi-cloud governance platform the Well-Architected Assessment functionality can simplify and streamline this part of the process by providing built-in comment and file attachment features for each best practice item included in an assessment. Users can add evidence directly in the assessment to show what was done to meet certain best practices, as well as create a milestone once an assessment is complete to log a snapshot of a workload that can be referenced later.

Clear assessment workflow is implemented by the multi-cloud governance platform. Progress through assessments with ease with a built-in workflow that helps you ensure you follow each step of the assessment process and account for each best practice item along the way. The multi-cloud governance platform can start an assessment, go through the questions, remediate any violations it finds, then reach a finishing point where you're ready to create a milestone. Export assessment reports In addition to being able to monitor user assessment results directly in the multi-cloud governance platform web portal, you can also export results as reports (e.g. PDF or image file). This makes it easy to share the results of an assessment with other members of a team, or across departments.

The multi-cloud governance platform can integrate with AWS Well-Architected (WA). The multi-cloud governance platform the Well-Architected Assessment functionality supports one-directional integration with AWS Well-Architected, meaning it can send data directly from The multi-cloud governance platform to AWS. When a user completes an assessment, whatever best practices the user provides answers can be synced to AWS so that results show there as well. This is helpful for keeping information consistent across both The multi-cloud governance platform and AWS environments. The multi-cloud governance platform's mission is to not only help with assessing cloud posture, but to provide a clear path to realizing well-architected workloads.

Federated Data Procurement Using Probabilistic Information Matching Via Domain Specific Heuristics

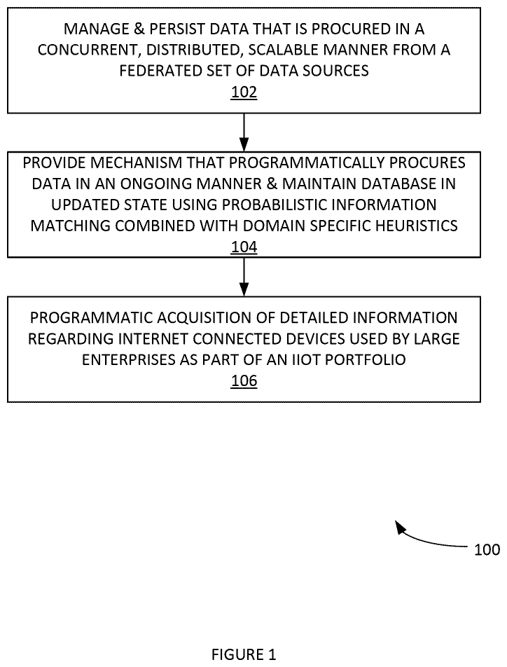

FIG. 1 illustrates an example process 100 for federated data procurement using probabilistic information matching via domain specific heuristics, according to some embodiments.

Process 100 can manage and persist data that is procured in a concurrent, distributed, scalable manner from a federated set of data sources in step 102. Process 100 can maintain this data in an updated state.

In step 104, process 100 provides a mechanism that can programmatically procure data in an ongoing manner and maintain the database updated by using probabilistic information matching combined with domain specific heuristics.

Process 100 can be used for the programmatic acquisition of detailed information regarding internet connected devices used by large enterprises as part of their Industrial Internet of Things (IIoT) portfolio in step 106. In this way, process 100 can enable the ongoing, programmatic acquisition of device information related to the IIoT using a federated procurement strategy via probabilistic information matching using domain specific heuristics.

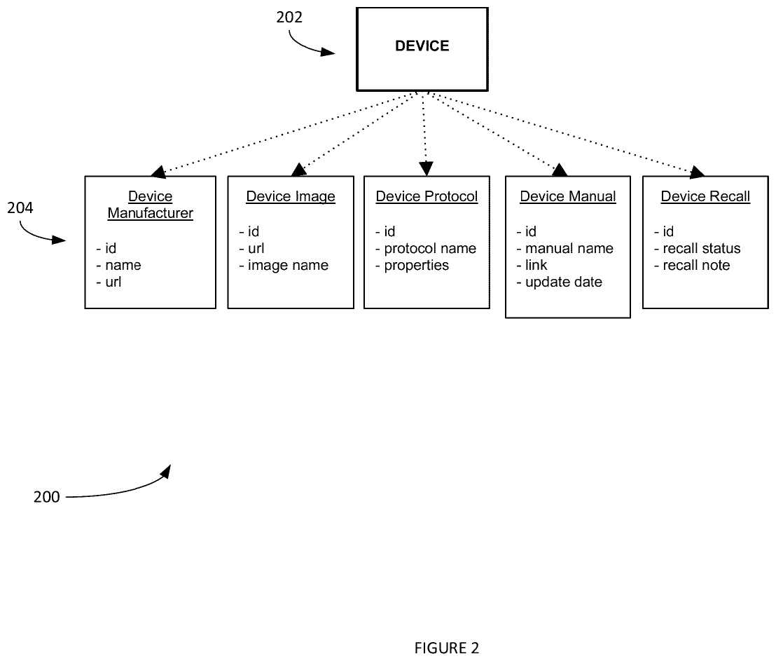

FIG. 2 illustrates an example schematic 200 useful for maintaining an IIoT device database up to date, according to some embodiments. Schematic 200 illustrates an example use case where the process 100 (and/or processes 500-600) can be used to maintain an IIoT device database up to date. Device 202 can be a logical construct that is composed of various properties that make up a canonical IIoT device. Device attributes 204 are now discussed. Device Manufacturer contains the relevant details regarding the IIoT device manufacturer (e.g. Schneider Electric, etc.). Device Image contains the details regarding the set of images for a specific device. Device Protocol contains the communication protocols required to connect with. Device manual lists the set of user manuals associated with a specific device.

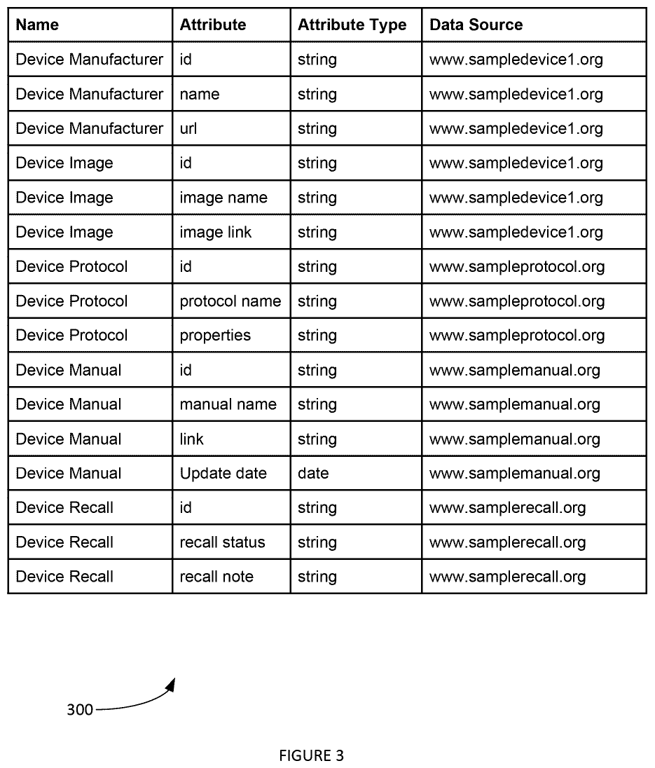

FIG. 3 illustrates another example process 300 for federated data procurement using probabilistic information matching via domain specific heuristics, according to some embodiments. In step 302, process 300 can The process first starts with identifying the specific pieces of information that we need to procure and the sources for that information.

To illustrate this point, let's continue with the example outlined above where we are trying to gather information about a set of internet-connected devices. A table (e.g. table 400 infra) can be used for the properties that would be of interest for each connected device.

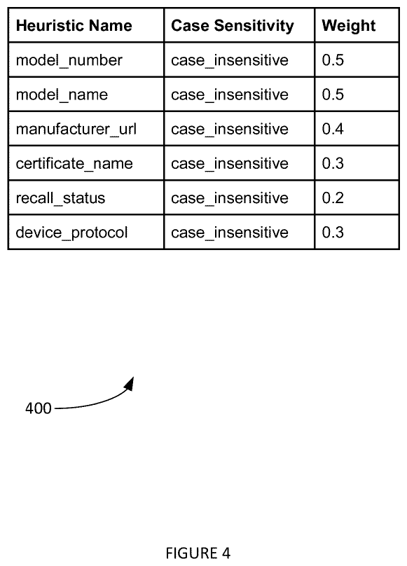

FIG. 4 illustrates an example table 400 showing an example set of properties for one or more connected devices, according to some embodiments.

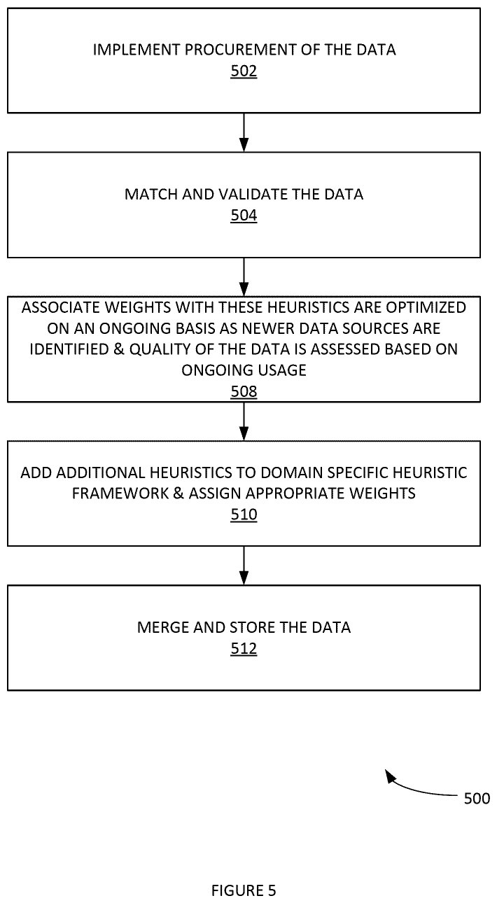

FIG. 5 illustrates another example process 500 for federated data procurement using probabilistic information matching via domain specific heuristics, according to some embodiments.

In step 502, process 500 implements procurement of the data. Each online data source has a variety of measures that they employ to not only ensure that the experience is optimized for their site but also meant to deter external entities such as bots from using their site in a manner that impairs the user experience on their site. These include the setting up of proxy servers, using forms, using sophisticated captcha mechanisms etc.

In addition to addressing these various mechanisms, process 500 can intelligently throttle the amount of scans that performed on the data source so that it remains within the bounds of normal site usage while still working concurrently.

In step 504, process 500 matches and validates the data. Process 500 identifies the data to be stored, the data source and determining how to obtain the data that is important. Process 500 can match the procured data with the data that is currently present in the database and validating data efficacy of the new data.

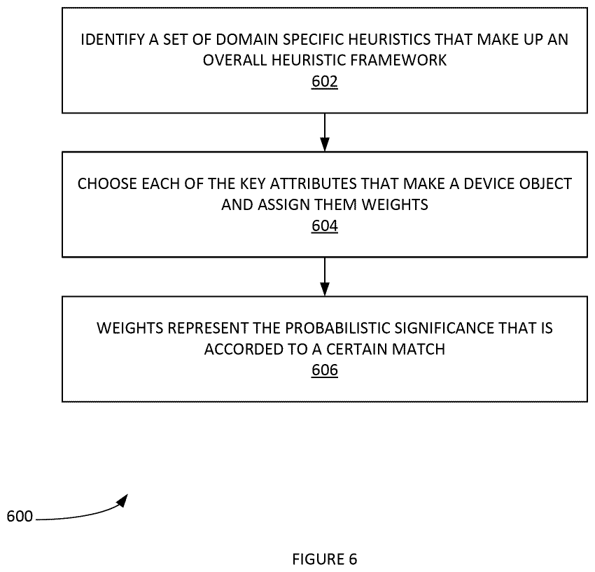

FIG. 6 illustrates an example process 600 for matching and validating the data, according to some embodiments. Step 504 can use process 600 for matching and validating the data. Process 600 can identify a set of domain specific heuristics that make up an overall heuristic framework in step 602. In this instance, process 500 can choose each of the key attributes that make a device object and assign them weights in step 604. These weights represent the probabilistic significance that is accorded to a certain match in step 606 (e.g. see FIG. 4, etc.).

Different discovered attributes will contribute more to a match than others. For instance a “product SKU” would have a high weight since it is very specific and gives high confidence that we are matching on the correct product. A “model number” would have a lower weight since they may be shared between different products. A “product name” would have an even lower weight because it is even more ambiguous.

The probabilistic significance is a measure of how much information is gained through matching on a particular attribute. In practice these are heuristics and are assigned based on testing and validating the results and picking values that give good results in real usage.

In step 506, process 500 can associate the weights with these heuristics are optimized on an ongoing basis as newer data sources are identified and the quality of the data is assessed based on ongoing usage. The quality can be assessed by running the data procurement process and evaluating the updates to the data. This was always done by hand, though other more automated and sophisticated methods could be used.

Process 500 can run the process, compare the new data to the old data and verify that the information added is accurate. The weights can be fine-tuned to address any issues in the process as data sources change or new data sources are added.

In step 508, over time as more information is collected, process 500 can add additional heuristics to the domain specific heuristic framework and assign appropriate weights while existing heuristics could get deprecated or could have their weights.

In step 510, process 500 can merge and store the data. The data can be merged at various dimensions; the existing database can be entirely replaced by the new data or specific device categories can be replaced or specific attributes within specific device categories can be replaced with the new data. The ultimate decision is made up of the following factors. The overall effective probability of an accurate match. The date when the last update was made. The amount of new data that is available for a specific device. The data for each device is stored along with its hash so that data comparisons using the hash are faster.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by this United States patent:

1. A computerized method for federated data procurement using probabilistic information matching via domain specific heuristics, comprising:
implementing procurement of the data from a plurality of online data sources, wherein each online data source comprises a plurality of measures;
matching and validating the data by:
identifying the data to be stored,
identifying a data source of the data,
matching a procured data with the data that is currently present in a database and validating data efficacy of the data; and
identifying a set of domain specific heuristics that make up an overall heuristic framework;
associating a plurality of weights with the plurality of set of domain specific heuristics that are optimized on an ongoing basis as newer data sources are identified; and
detecting that new information is collected and adding a plurality of additional heuristics to the domain specific heuristic frameworks.

2. The computerized method of claim 1, wherein the data comprises IIoT data.

3. The computerized method of claim 2, wherein the plurality of measures ensures that an experience is optimized for a specified site.

4. The computerized method of claim 3, wherein the plurality of measures deters an external bot entity from using a site in a manner that impairs a user experience on the site.

5. The computerized method of claim 1 further comprising:
assigning one or more appropriate weights while the plurality of heuristics are deprecated.

6. The computerized method of claim 1 further comprising:
assigning one or more appropriate weights while the plurality of heuristics are reassigned a plurality of new weights.

7. The computerized method of claim 1 further comprising:
assessing a quality of the data based on an ongoing usage of the data.

8. The computerized method of claim 1 further comprising:
choosing each of the key attributes that make a device object and assign them weights.

9. The computerized method of claim 8, wherein the weights represent a probabilistic significance that is accorded to a certain match.

10. The computerized method of claim 1 further comprising:
intelligently throttling a set of scans that are performed on the data source.

11. The computerized method of claim 10 wherein the data source remains within one or more bounds of normal site usage while still working concurrently.
